(19) United States
(12) Patent Application Publication
(10) Pub. No.: US 2014/0274446 A1
(43) Pub. Date: Sep. 18, 2014

(54) GOLF CLUB

(71) Applicant: Taylor Made Golf Company, Inc., Carlsbad, CA (US)

(72) Inventors: Mark Vincent Greaney, Vista, CA (US); Parker Drennan, Oceanside, CA (US); Sanjay Kuttappa, Oceanside, CA (US); Bing-Ling Chao, San Diego, CA (US)

(73) Assignee: Taylor Made Golf Company, Inc., Carlsbad, CA (US)

(21) Appl. No.: 14/210,000

(22) Filed: Mar. 13, 2014

Related U.S. Application Data
(60) Provisional application No. 61/792,529, filed on Mar. 15, 2013.

(51) Int. Cl. A63B 53/04; B41F 17/00; A63B 59/00; A63B 53/02; A63B 53/06

(52) U.S. Cl. CPC A63B 53/0466; A63B 53/02; A63B 53/06; A63B 59/0074; B41F 17/00
USPC 473/307; 473/342; 473/329; 473/335; 101/483

(57) ABSTRACT

A golf club-head can have a body having a crown, a heel, a toe, and a sole, the body defining a front opening; and a face plate closing the front opening of the body, the face plate comprising a lay-up of multiple, composite prepreg plies, wherein at least a portion of the plies comprise a plurality of elongated prepreg strips arranged in a crisscross pattern defining an overlapping region where the strips overlap each other. The face plate also includes an exterior and interior surface and having an image or indicia printed on the exterior surface.

### CROSS REFERENCE TO RELATED APPLICATION

This application claims the benefit of U.S. Provisional Application No. 61/792,529 filed Mar. 15, 2013, which is herein incorporated by reference in its entirety.

### BACKGROUND

With the ever-increasing popularity and competitiveness of golf, substantial effort and resources are currently being expended to improve golf club performance in order to maximize the enjoyment and success of increasingly more golfers. Much of the recent improvement activity has involved the combination of the use of new and increasingly more sophisticated materials in concert with advanced club-head engineering. For example, modern “wood-type” golf clubs (notably, “drivers,” “fairway woods,” and “utility or hybrid clubs”), with their sophisticated shafts and non-wooden club-heads, bear little resemblance to the “wood” drivers, low-loft long-irons, and higher numbered fairway woods used years ago. These modern wood-type clubs are generally called “metalwoods.”

The current ability to fashion metalwood club-heads of strong, light-weight metals and other materials has allowed the club-heads to be made hollow. Use of materials of high strength and high fracture toughness has also allowed club-head walls to be made thinner, which has allowed increases in club-head size, compared to earlier club-heads. Larger club-heads tend to provide a larger “sweet spot” on the strike plate and to have higher club-head inertia, thereby making the club-heads more “forgiving” than smaller club-heads. Characteristics such as size of the sweet spot are determined by many variables including the shape profile, size, and thickness of the strike plate as well as the location of the center of gravity (CG) of the club-head.

An exemplary metalwood golf club such as a driver or fairway wood typically includes a hollow shaft having a lower end to which the club-head is attached. Most modern versions of these club-heads are made, at least in part, of a light-weight but strong metal such as titanium alloy. The club-head comprises a body to which a face plate (used interchangeably herein with the terms “face” or “face insert” or “striking plate” or “strike plate”) is attached or integrally formed. The strike plate defines a front surface or strike face that actually contacts the golf ball.

Regarding the total mass of the metalwood club-head as the club-head's mass budget, at least some of the mass budget must be dedicated to providing adequate strength and structural support for the club-head. This is termed “structural” mass. Any mass remaining in the budget is called “discretionary” or “performance” mass, which can be distributed within the metalwood club-head to address performance issues, for example. Thus the ability to reduce the structural mass of the metalwood club-head without compromising strength and structural support provides the potential for increasing discretionary mass and hence improved club performance.

Some current approaches to reducing structural mass of a metalwood club-head are directed to making at least a portion of the club-head of an alternative material. Whereas the bodies and face plates of most current metalwoods are made of titanium alloy, several “club-heads are available that are made, at least in part, of components formed from either graphite/epoxy-composite (or other suitable composite material) and a metal alloy. For example, in one group of such club-heads a portion of the body is made of carbon-fiber (graphite)/epoxy composite and a titanium alloy is used as the primary face-plate material. Other club-heads are made entirely of one or more composite materials. Graphite composites have a density of approximately 1.5 g/cm³, compared to titanium alloy which has a density of 4.5 g/cm³, which offers tantalizing prospects for providing more discretionary mass in the club-head.

Composite materials that are useful for making metalwood club-head components comprise a fiber portion and a resin portion. In general, the resin portion serves as a “matrix” in which the fibers are embedded in a defined manner. In a composite for club-heads, the fiber portion is configured as multiple fibrous layers or plies that are impregnated with the resin component. The fibers in each layer have a respective orientation, which is typically different from one layer to the next and precisely controlled. The usual number of layers is substantial, e.g., fifty or more. During fabrication of the composite material, the layers (each comprising respectively oriented fibers impregnated in uncured or partially cured resin; each such layer being called a “prepreg” layer) are superposed in a “lay-up” manner. After forming the prepreg lay-up, the resin is cured to a rigid condition.

Another important factor in modern metalwood club-head design is the construction of the face plate, as its mass can contribute significantly to the total weight of the club-head and impact of the face plate with the golf ball results in some rearward instantaneous deflection of the face plate. Thus the ability to utilize lighter composite materials in the construction of the face plate can provide some significant performance advantages

Carbon-fiber (graphite) composites are inherently black in color. As the face plate is the main portion of a metalwood club that the golfer aligns with at address, its shading can make the club be perceived as more open or closed. For instance, under some circumstances a black lower heel portion of the face could make the club head appear more closed at the normal address position. Thus it would be highly advantageous to have a method of varying the face color or pattern of the image on the composite face plate to change the perceived degree of how open or closed the face of the club head appears to the golfer at address.

In addition, customization of golf clubs is becoming more and more popular. U.S. Pat. No. 5,924,939 discloses a putter with a recess having a first insert with projections in the form of a word with a second insert over the first insert. U.S. Pat. No. 6,024,650 to Reeves discloses a putter head having the shape of a quarter cylinder and having at least an outer surface of a material capable of accepting an imprint. U.S. Pat. No. 5,643,111 discloses a method of attaching a label on the rear cavity of a putter and covering it with a clear resin for durability. Finally, U.S. Pat. No. 5,104,457 discloses a method for customizing a golf club by placing a circular emblem within an aperture on the back surface of the cavity of a putter or iron. However, there is little in the way of prior art which discloses metalwood golf club heads that have a face plate with indicia printed directly on its external surface. This is in part due to the difficulties of printing on the steel and titanium face plates typically employed in metalwood face plates as well as the durability issues which come from repeated high velocity impacts between the face plate and the golf ball. Thus to date, metalwood golf club face plates provide an advertising canvas that is underutilized.

The golf club constructions of disclosed herein provide for a golf club having a composite face and having one or more highly durable indicia on the face which allows for improved alignment of the face while providing for ease of customization by the golfer or manufacturer, including advertising or other marketing placement by the manufacturer. The methods disclosed herein also include a method for placing indicia or any photographic image in any color scheme on a composite face plate of a metalwood while maintaining the required durability of the image.

### SUMMARY

The foregoing will become more apparent from the following figures and detailed description.

The structures disclosed herein include a golf club-head having a body having a crown, a heel, a toe, and a sole, the body defining a front opening; and a face plate having closing the front opening of the body, the face plate made from a lay-up of multiple, composite prepreg plies, wherein at least a portion of the plies include a plurality of elongated prepreg strips arranged in a crisscross pattern defining a region where the strips overlap each other. The face plate also includes an exterior and interior surface and having an image or indicia printed on the exterior surface.

The structures disclosed herein also include a golf club, having a body having a crown, a heel, a toe, and a sole, the body defining a front opening; and a face plate closing the front opening of the body, the face plate including a lay-up of multiple, composite prepreg plies, wherein at least a portion of the plies comprise a plurality of elongated prepreg strips arranged in a crisscross pattern defining a region where the strips overlap each other. The face plate has an exterior and interior surface with an image or indicia printed on the exterior surface. The body also includes a hosel having an upper bearing surface; and a hosel bore defining a hosel bore axis, and an adjustable sleeve having more than one engaging surfaces that engage with the body to restrict rotation of the sleeve relative to the body such that the sleeve is configured to be secured within the hosel bore in a plurality of discrete rotational positions relative to the hosel bore axis. The sleeve also includes a shaft bore defining a shaft bore axis that forms a sleeve angle with the hosel bore axis when the sleeve is secured within the hosel bore, the shaft bore being secured to a distal end portion of the shaft such that the shaft extends along the shaft bore axis. The sleeve also includes a releasable retainer which secures a distal end portion of the sleeve to the body in one of the rotational positions. The square loft angle of the golf club head can be adjusted to a plurality of different values by changing the rotational position of the sleeve within the hosel bore; and when the sleeve is secured to the body via the retainer in one of the rotational positions, an intermediate portion of the sleeve extending axially from a lowest portion of the upper bearing surface of the hosel to a distal end of the shaft is under a tension that is constant along the axial length of the intermediate portion of the sleeve.

The structures disclosed herein also include a golf club, having a body having a crown, a heel, a toe, and a sole, the body defining a front opening; and a face plate closing the front opening of the body, the face plate including a lay-up of multiple, composite prepreg plies, wherein at least a portion of the plies comprise a plurality of elongated prepreg strips arranged in a crisscross pattern defining a region where the strips overlap each other. The face plate also includes an exterior and interior surface and has an image or indicia printed on the exterior surface. The club head body also has a rotatable sole piece which can be positioned at a plurality of rotational and axial positions with respect to an axis extending through the sole piece. The adjustable sole piece can be locked on the sole at three or more discrete selectable positions, where the adjustable sole piece extends a different distance from the sole at each of the three or more positions. The adjustable sole piece also has a releasable locking mechanism configured to lock the sole piece at a selected one of the three or more rotational positions on the sole, where the locking mechanism includes a screw extending through the sole piece and into a threaded opening in the sole of the club head body.

The structures disclosed herein also include a golf club having a body having a crown, a heel, a toe, and a sole, and a front opening; and a face plate closing the front opening, the face plate made from a lay-up of multiple, composite prepreg plies, where a portion of the plies comprise a plurality of elongated prepreg strips arranged in a crisscross pattern defining an overlapping region where the strips overlap each other. The face plate has an exterior and interior surface and has an image or indicia printed on the exterior surface. The body also has an interior cavity; and a first weight port and a second weight port formed in the body; and at least one weight configured to be retained at least partially within a weight port; and a first weight having a mass between about 1 g and about 18 g configured to be retained at least partially within the first weight port and a second weight having a mass between about 1 g and about 18 g configured to be retained at least partially within the second weight port.

The structures disclosed herein also include a golf club assembly including a shaft, a body having a crown, a heel, a toe, and a sole, and a front opening; and a face plate closing the front opening of the body, made from a lay-up of multiple, composite prepreg plies, where at least a portion of the plies comprise a plurality of elongated prepreg strips arranged in a crisscross pattern defining an overlapping region where the strips overlap each other. The face plate has an exterior and interior surface and has an image or indicia printed on the exterior surface. The golf club body has an interior cavity; having at least a first weight port and a second weight port formed in the body; and at least one weight configured to be retained at least partially within a weight port; and at least a first weight having a mass between about 1 g and about 18 g configured to be retained at least partially within the first weight port and a second weight having a mass between about 1 g and about 18 g configured to be retained at least partially within the second weight port. The golf club body also has an adjustable sole portion (that is adjustable relative to the body to adjust a sole angle of the club head). The golf club head also has hosel with an opening and a sleeve made to fit in the hosel opening. The golf club head also has an opening made to receive a lower end portion of the shaft and support the shaft relative to the club head at a plurality of orientations. The sleeve is made to be received in the hosel opening at a plurality of discrete rotational positions with respect to a longitudinal axis of the sleeve, with at least two of the rotational positions of the sleeve corresponding to different shaft orientations relative to the club head. The golf club head also has a releasable mechanical fastener which secures the shaft and the sleeve to the club head.

The methods disclosed herein include a method of manufacturing a golf club head having a body having a crown, a heel, a toe, and a sole, the body defining a front opening; and a face plate closing the front opening of the body. The face plate is made of a lay-up of multiple, composite prepreg plies, where at least a portion of the plies include a plurality of elongated prepreg strips arranged in a crisscross pattern defining an overlapping region where the strips overlap each other. The face plate also has an exterior and interior surface with an image or indicia printed on the exterior surface. The image is printed on the face plate surface using a method using the following steps;
1. preparing the exterior surface of the face plate for receiving at least one indicia;
2. providing a digital image having at least one color;
3. providing a pad-printing cliché;
4. etching the image onto the surface of the pad-printing cliché;
5. distributing a layer of ink over the etched pad-printing cliché;
6. providing at least one pad for transferring the ink from the surface of the pad-printing cliché to the exterior surface of the face plate; and
7. transferring the image from the substrate to the to the exterior surface of the face plate.

### BRIEF DESCRIPTION OF DRAWINGS

FIG. 1 is a depiction of an exemplary hollow “metalwood” club-head.

FIG. 2A is a depiction of a personalized graphical image on a face insert plate of the club head.

FIG. 2B is a depiction of a shaded image on a face insert plate of the club head providing for improved alignment of the face.

FIG. 2C is another embodiment of a depiction of a shaded image on a face insert plate of the club head providing for improved alignment of the face.

FIG. 3 is an exploded view of the golf club head.

FIG. 4 is a bottom and rear side perspective view of a club head having four weight recesses.

FIG. 5 is a side elevational view of the club head of FIG. 4, depicted from the heel side of the club head.

FIG. 6 is a rear elevational view of the club head of FIG. 4.

FIG. 7 is a cross-sectional view of the club head of FIG. 4, taken along line 5-5 of FIG. 6.

FIG. 8 is a side elevational view of two weight assemblies of about 10 grams and two weight screws of about 2 grams.

FIG. 9 is an enlarged cross-sectional view of a golf club head having a removable shaft assembly, in accordance with another embodiment.

FIG. 10 is a perspective view of the shaft sleeve of the assembly shown in FIG. 9.

FIG. 11 is a side elevation view of the shaft sleeve of FIG. 10.

FIG. 12 is a bottom plan view of the shaft sleeve of FIG. 10.

FIG. 13 is a cross-sectional view of the shaft sleeve taken along line 47-47 of FIG. 12.

FIG. 14A is a front view of a golf club head, according to another embodiment.

FIG. 14B is a side view of the golf club head of FIG. 14A.

FIG. 14C is a rear view of the golf club head of FIG. 14A.

FIG. 14D is a bottom view of the golf club head of FIG. 14A.

FIG. 14E is a cross-sectional view of the golf club head of FIG. 14B, taken along line A-A.

FIG. 14F is a cross-sectional view of the golf club head of FIG. 14C, taken along line H-H

FIG. 15 is an exploded perspective view of the golf club head of FIG. 14A.

FIG. 16A is a bottom view of a body of the golf club head of FIG. 14A, showing a recessed cavity in the sole.

FIG. 16B is a cross-sectional view of the golf club head of FIG. 16A, taken along line G-G.

FIG. 16C is a cross-sectional view of the golf club head of FIG. 16A, taken along line E-E.

FIG. 16D is an enlarged cross-sectional view of a raised platform or projection formed in the sole of the club head of FIG. 16A.

FIG. 16E is a bottom view of a body of the golf club head of FIG. 14A, showing an alternative orientation of the raised platform or projection.

FIG. 17A is top view of an adjustable sole portion of the golf club head of FIG. 14A.

FIG. 17B is a side view of the adjustable sole portion of FIG. 17A.

FIG. 17C is a cross-sectional side view of the adjustable sole portion of FIG. 17A.

FIG. 17D is a perspective view of the bottom of the adjustable sole portion of FIG. 17A.

FIG. 17E is a perspective view of the top of the adjustable sole portion of FIG. 17A.

### DETAILED DESCRIPTION

The following describes embodiments of golf club heads for metalwood type golf clubs, including drivers, fairway woods, utility clubs (also known as hybrid clubs) and the like.

The following makes reference to the accompanying drawings which form a part hereof, wherein like numerals designate like parts throughout. The drawings illustrate specific embodiments, but other embodiments may be formed and structural changes may be made without departing from the intended scope of this disclosure. Directions and references (e.g., up, down, top, bottom, left, right, rearward, forward, heelward, toeward, etc.) may be used to facilitate discussion of the drawings but are not intended to be limiting. For example, certain terms may be used such as “up,” “down,”, “upper,” “lower,” “horizontal,” “vertical,” “left,” “right,” and the like. These terms are used, where applicable, to provide some clarity of description when dealing with relative relationships, particularly with respect to the illustrated embodiments. Such terms are not, however, intended to imply absolute relationships, positions, and/or orientations. For example, with respect to an object, an “upper” surface can become a “lower” surface simply by turning the object over. Nevertheless, it is still the same object.

Accordingly, the following detailed description shall not to be construed in a limiting sense and the scope of property rights sought shall be defined by the appended claims and their equivalents.

The main features of an exemplary hollow “metalwood” club-head 10 are depicted in FIG. 1. The club-head 10 comprises a hollow body 14. The body 14 also has a heel 20, a toe 22, a rear portion 32, a sole 24, a top or crown 26, and a hosel 28. The body 14 has walls and defines a front opening 16. The club-head 10 also comprises a face plate, strike plate, or striking plate 12. The face plate 12 typically is convex, and has an external (“striking”) surface (face) 13. A face support 18 is disposed about the front opening 16. Around the front opening 16 is a “transition zone” 15 that extends along the respective forward edges of the heel 20, the toe 22, the sole 24, and the crown 26. The transition zone 15 effectively is a transition from the walls of the body 14 to the face plate 12. The opening 16 receives the face plate 12, which rests upon and is bonded to the face support 18 and transition zone 15, thereby enclosing the front opening 16. The transition zone 15 includes a sole-lip region 18d, a crown-lip region 18a, a heel-lip region 18c, and a toe-lip region 18b. The hosel 28 defines an opening 30 that receives a distal end of a shaft (not shown).

As used herein, the skirt 34 is the side portion of the club-head 10 between the crown 26 and the sole 24 that extends across a periphery of the club head, excluding the striking surface 13, from the toe portion 22, around the rear portion 32, to the heel portion 20.

In some embodiments, the striking surface 13 can have a bulge and roll curvature.

The body 10 can be made from a metal alloy (e.g., an alloy of titanium, an alloy of steel, an alloy of aluminum, and/or an alloy of magnesium), a composite material, such as a graphitic composite, a ceramic material, or any combination thereof. The crown 26, sole 24, and skirt 34 can be integrally formed using techniques such as molding, cold forming, casting, and/or forging.

The metal wood club head 10 also has a volume, typically measured in cubic-centimeters (cm³), equal to the volumetric displacement of the club head 10, assuming any apertures are sealed by a substantially planar surface. (See United States Golf Association “Procedure for Measuring the Club Head Size of Wood Clubs,” Revision 1.0, Nov. 21, 2003). In the case of a driver, the golf club head 2 has a volume between approximately 120 cm³ and approximately 460 cm³, and a total mass between approximately 145 g and approximately 245 g. In the case of a fairway wood, the golf club head 2 has a volume between approximately 120 cm³ and approximately 460 cm³, and a total mass between approximately 145 g and approximately 260 g. In the case of a utility or hybrid club the golf club head 2 has a volume between approximately 120 cm³ and approximately 460 cm³, and a total mass between approximately 145 g and approximately 280 g.

In some embodiments, at least a portion of the face plate 12 is made of a composite including multiple plies or layers of a fibrous material (e.g., graphite, or carbon, fiber) embedded in a cured resin (e.g., epoxy). An exemplary thickness range of the composite portion of the face plate is 8.0 mm or less.

Composite face plates for use in the metalwood golf clubs disclosed herein may be fabricated using the procedures described in U.S. patent application Ser. No. 10/442,348 (now U.S. Pat. No. 7,267,620), Ser. No. 10/831,496 (now U.S. Pat. No. 7,140,974), Ser. Nos. 11/642,310, 11/825,138, 11/998,436, 11/895,195, 11/823,638, 12/004,386, 12,004,387, 11/960,609, 11/960,610, and 12/156,947, which are incorporated herein by reference. The composite material can be manufactured according to the methods described at least in U.S. patent application Ser. No. 11/825,138, the entire contents of which are herein incorporated by reference.

The composite portion of the face plate is made as a lay-up of multiple prepreg plies. For the plies the fiber reinforcement and resin are selected in view of the club-head's desired durability and overall performance. In order to vary the thickness of the lay-up, some of the prepreg plies comprise elongated strips of prepreg material arranged in one or more sets of strips. The strips in each set are arranged in a cross-cross, overlapping pattern so as to add thickness to the composite lay-up in the region where the strips overlap each other. The strips desirably extend continuously across the finished composite part; that is, the ends of the strips are at the peripheral edge of the finished composite part. In this manner, the longitudinally extending reinforcing fibers of the strips also can extend continuously across the finished composite part such that the ends of the fibers are at the periphery of the part. Consequently, during the curing process, defects can be shifted toward a peripheral sacrificial portion of the composite layup, which sacrificial portion subsequently can be removed to provide a finished part with little or no defects. Moreover, the durability of the finished part is increased because the free ends of the fibers are at the periphery of the finished part, away from the impact zone.

In tests involving certain club-head configurations, composite portions formed of prepreg plies having a relatively low fiber areal weight (FAW) have been found to provide superior attributes in several areas, such as impact resistance, durability, and overall club performance. (FAW is the weight of the fiber portion of a given quantity of prepreg, in units of g/m″) FAW values below 200 g/rrr′, preferably below 100 g/rrr′ and more preferably below 70 g/rn″, can be particularly effective. A particularly suitable fibrous material for use in making prepreg plies is carbon fiber, as noted.

The composite desirably is configured to have a relatively consistent distribution of reinforcement fibers across a cross-section of its thickness to facilitate efficient distribution of impact forces and overall durability. In addition, the thickness of the face plate 12 can be varied in certain areas to achieve different performance characteristics and/or improve the durability of the club-head. The face plate 12 can be formed with any of various cross-sectional profiles, depending on the club-head's desired durability and overall performance, by selectively placing multiple strips of composite material in a predetermined manner in a composite lay-up to form a desired profile.

Texture can be incorporated into the surface of the tool used for forming the composite plate, thereby allowing the textured area to be controlled precisely and automatically. For example, in an embodiment having a composite plate joined to a cast body, texture can be located on surfaces where shear and peel are dominant modes of failure. Methods of introducing such texture are more fully disclosed in copending U.S. application Ser. No. 11/960,609 filed on Dec. 1, 2007, Ser. No. 13/111,715 filed on May 19, 2011 and Ser. No. 13/728,683 filed on 27 Dec., 2012, the entire contents of each of which are incorporated herein by reference.

Typically the final part is sized larger than the intended final size and after reaching full-cure, the components are subjected to manufacturing techniques (machining, forming, etc.) that achieve the specified final dimensions, size, contours, etc., of the components for use as face plates on club-heads. These techniques are described in more detail in U.S. Pat. No. 7,874,937, the entire contents of which are incorporated by reference herein. Conventional CNC trimming can be used to remove the sacrificial portion of the fully-cured lay-up. However, because the tool applies a lateral cutting force to the part (against the peripheral edge of the part), it has been found that such trimming can pull fibers or portions thereof out of their plies and/or induce horizontal cracks on the peripheral edge of the part. These defects can cause premature delamination or other failure.

In certain embodiments, the sacrificial portion of the fully-cured lay-up is removed by water-jet cutting. In water-jet cutting, the cutting force is applied in a direction perpendicular to the prepreg plies (in a direction normal to the front and rear surfaces of the lay-up), which minimizes the occurrence of cracking and fiber pull out. Consequently, water-jet cutting can be used to increase the overall durability of the part.

The composite face plate as described above need not be coextensive (dimensions, area, and shape) with a typical face plate on a conventional club-head. Alternatively, a subject composite face plate can be a portion of a full-sized face plate, such as the area of the “sweet spot.” Both such composite face plates are generally termed “face plates” herein. Further, the composite plate itself (without additional layers of material bonded or formed on the composite plate) can be used as the face plate 12.

Once the face plate material has been formed, a graphical image is then transferred to its surface using a method for forming the image on the surface of the face plate material. The image can be one extracted from an existing preferably photographic-type image from a memory or by directly uploading the physical embodiment of the image into a memory. For example, the image can be directly downloaded from a database such as that associated with a web site of a global communications network or from graphical images stored in their own respective database, Also for example, a digital camera can be used to acquire the image. The image can then either be transferred directly to a manufacturer's data acquisition medium, e.g., an image server, or to a database accessible by the manufacturer's data acquisition medium, typically via a network system. A photographer can either transmit a removable storage medium of the digital camera to the manufacturer, directly download the camera to the manufacturer's network interface, upload the images from a computer to a web site of the global network, or accomplish the task by any other equivalent method as known by those skilled in the art.

In another embodiment, a scanner can convert an embodiment of the image, a developed photographic print, or a negative into an image scanned into a digital medium or memory, whereby the digitized image can be easily electronically transferred. For example, a flatbed scanner or wand can be used to scan an image or a developed photographic print of the target image, a negative scanner can be used to scan photographic negative strips. As an alternative methodology, a point-of-sale machine (not shown), as understood by those skilled in the art, can be used to access an image stored in the memory of a digital camera or other imaging device (scanner, personal digital assistant, hand-held computer), and perform a point-of-sale transaction for storing at least one of the images at a remote site accessible to the manufacturer's data acquisition medium. Other alternative methodologies include non-electronic transfer to the manufacturer of an embodiment of the image to be positioned on the club head. Electronic methods, however, are generally preferred due to cost efficiency where the image is to be a custom image or one made in the limited quantities.

The system for forming a club head having images thereon also includes a method for forming the image on the outer surface of the composite face plate material such as the substantially flat side outer surface portion. Generally, when one refers to forming an image, one is referring to a method that implements a method for transferring an embodiment of the image to the outer surface of the face plate.

There are a number of methods available for transferring the digital image to the outer surface of the composite face plate. Of the various methods available, halftone printing is one of the most common for color printing. In halftone printing, a multicolor image is photographed through halftone screens with color filters to reproduce the three primary colors, cyan, yellow and magenta, plus black. The halftone screens generally have a grid pattern of intersecting opaque lines impregnated on a clear substrate which leaves an array of clear dots. The screens break an image into evenly spaced dots that are larger in the dark areas of the image and smaller in the light areas. The screens vary in quality. The quality or fineness of the screens, measured in dots per inch are directly proportional to their cost and ease of use. A very coarse screen may provide as little as 25,000 dots per square inch but be very easy to make and use, whereas finer quality screens which are harder to make and use, commonly provide image sharpness and detail in excess of 90,000 dots per square inch.

Another method available is the letterpress, known as relief printing. Relief printing uses metal type or engravings where the image areas are raised in relief above non-image areas. The ink is applied to the raised surfaces and transferred directly onto the face plate. Similar or related methods includes offset-printing, also known as lithography, gravure printing, and serigraphy, also known as silk-screen printing. Offset-printing uses a plate treated so that ink will adhere only to the areas that will print the design. The plate transfers its ink to a rubber cylinder which in turn offsets it onto the item receiving the image. In offset printing, color printing is achieved by photographically separating from the original picture, the four basic colors (black, magenta, yellow, and cyan), making a plate for each color, and then using the plates to print the colors successively over one another. In gravure printing, the image areas are instead recessed into the metal plate. In serigraphy, paint is applied to a fabric screen. The images formed by the paint penetrate areas not blocked by a stencil. Several stencils are used to produce a multicolored print. The process can be used for printing full-color images onto various types of objects. For comparative purposes, all these methods have the capability of printing to a resolution as high as the equivalent of 40,000 dots per square inch, or more.

Another method available for printing fill-color images is a thermal transfer printing device. Thermal transfer printing involves the transfer of an image on an object by heat and contact pressure using a device such as a thermal press. Thermal transfer printing using a thermal transfer press is essentially a two-step process. First, a transfer surface is made to hold the image. Second, the image on the transfer surface is transferred to the receiving surface of the face plate. The transfer process includes transferring by holding the printed stencil in tight contact with the receiving surface while heat and pressure is applied. The heat and pressure is maintained for a sufficient time to allow completion of a sublimation process to occur which results in the image transfer. The typical thermal transfer press typically includes a heater block assembly with thermal conductive material attached to the transfer surface to heat the image. Thermal-wax-transfer printers and dye-sublimation printers provide another method of heat transfer printing. Thermal-wax-transfer printers and dye-sublimation printers, in their current form, use heat to transfer color pigment from a color ribbon. For comparative purposes, thermal transfer printing has been known to provide a quality equivalent to that of approximately 17,700 dots per square inch, or more.

Another method available for printing fill-color images is ink-jet (bubble-jet) printing. Inkjet printing provides a non-impact method for producing images such as image in response to digital signals by the deposition of ink droplets in a pixel-by-pixel manner to an image-recording substrate. The typical ink-jet printing assembly includes a controller and associated wiring, print head, and stepper motors to drive the print head. Functionally, the controller receives the image from the data acquisition medium, activates the stepper motors to position the printhead, and controls the flow of ink, as will be understood by those skilled in the art, to form the image.

Most preferably, the image is transferred to the face plate via a pad printing process. Pad printing is an indirect intaglio process during which depressions corresponding to the logo, indicia or photographic image of choice are created or etched on a flat surface called “the plate” or pad printing cliché. Ultimately the depressions are then filled with ink and the actual printing process begins by spreading ink across the surface of the plate with a spatula. Excess ink is then scraped back into an ink reservoir using a “doctor blade” which leaves ink only in the depressions on the plate. As the plate is exposed to air, thinner evaporates from the remaining ink in the depressions causing the ink surface to become tacky. A smooth, resilient, stamp block of silicone rubber is used to lift ink from the plate and transfer it to the face plate substrate surface. The stamp block is termed a “pad” and it is this term that has lent its name to the printing process. For images having multiple colors, multiple plates are created that are dedicated to each individual color of the image to be printed.

The actual exposure procedure involves the initial transfer or printing of the digital image onto a clear film or “positive”. The positive is then placed on top of the cliché or printing plate.

There are two main types of printing plate materials: photopolymer and steel. Steel plates come in two forms: thin steel for medium to long runs, and thick steel for very long runs. Both steel plate types are generally processed by the plate supplier as it involves the use of specialized equipment. Photopolymer plates are a laminate of steel and plastic photopolymer material. They are preferred given their ease of use. These are typically used in short to medium production runs. This is the preferred form of cliché as it is the most economical and their resolution is extremely high, and even the finest details can be accurately reproduced. There are two basic types of photopolymer plate materials-fixed depth and variable depth plates. Fixed depth plates are just that—the depth of etch cannot be varied. Whereas variable depth plates allow the depth of etch to be optimized for a particular application.

The photopolymer side of the plate which is covered by the positive plate is exposed to UV light which hardens the photopolymer areas of the plate not protected by the image positive and leaves soft areas on the plate corresponding to the areas protected from the UV light by the image on the positive. In the case of the preferred variable depth relief photopolymer plates, the material is actually exposed to UV light twice: first with the positive of the intended artwork in place, followed by a second exposure in which the first formed image on the plate is covered with a halftone film or screen. If the etch process was to occur immediately after the first exposure, the still-soft underlying material would etch down to the metal backing and the image would be many times too deep. This second exposure utilizes a halftone film that is the means used to control etch depth. The halftone film contains a series of dots. For example, a 300-line, 85% halftone film equates to 300 dots per square inch. 85% refers to the tint (opaque area) of the film and the amount of area available for light to transmit through. In this case, 85% of the film is opaque allowing only 15% light transfer. The screen film can have frames of about 50 to 1,000 lines per inch or, more preferably, from about 100 to 300 lines per inch. For example, if the screen film has 80 lines/cm, there will be 64 small circular surfaces per mm², each with a diameter of 0.02 to 0.03 mm. The quality and sharpness of the printed image are still maintained, as the screen spots show only very slightly at the edges.

The higher the level of tint, the more the area of the image that is protected from the light, which results in a larger area of soft material. This unexposed soft material eventually gets “etched” or washed away, leaving the remaining exposed areas as raised “truncated cones” or “pyramids”. The method of etching or removal of the uncured polymer (to reproduce the resulting image in the form of an area of soft polymer interspersed with small truncated cones) is dependent on whether an alcohol-wash or water wash plate is used. In the former, the soft uncured polymer is etched away by washing the plate with alcohol whereas with the latter the plate is etched by washing with water. Water wash plates are the preferred plate because of less environmental and safety issues involved with the use of a water wash versus an alcohol wash. The washing process leaves an etched image on the plate having a depth of from about 10 to about 100 microns, preferably of from about 25 to about 80 microns, more preferably of from about 30 to about 60 microns.

In the next step in the process, the etched image is flooded (coated) with ink from an ink-containing cup “ink cup”) and then a so called doctor blade (steel ink blade) removes the excess ink from the flat printing plate, leaving a deposit of ink in the etched area only. An important benefit of the screen step is thus create a support structure of the small truncated cones in the etch to prevent the doctor blade from scooping ink as it passes over larger (open) areas of the graphic design i.e. preventing it from dropping into the open areas and remove too much ink in a non-uniform manner. After the doctor blade passes over the plate, the top layer of ink in the depressed form of the image becomes tacky as soon as it is exposed to the air.

In the next step a silicone transfer pad or tampon is lowered over the depressions in the surface of the plate, the transfer pad presses down onto the printing plate momentarily which causes it to compress. As the pad is compressed, it pushes air outward and causes the tacky ink to lift (transfer) from the etched artwork area as it sticks to the pad. As the pad lifts, it takes with it not only the tacky, adhering film of ink, but also the fluid ink underneath the tacky film. This film of ink is carried on the pad to the target area on the substrate surface. The time that elapses during this transfer process allows thinner to evaporate from the exposed surface of the ink on the silicone pad, and thus the ink surface facing away from the pad now becomes tacky. As the pad compresses down onto face plate substrate surface, the tacky film of ink adheres to the face plate substrate surface and separates from the pad as it is lifted from the surface. Then, the pad lifts off the substrate and returns to the home position, thus completing one print cycle. Also at the earlier point in the cycle when the transfer pad first moves forward from the plate towards the substrate, the ink cup also moves to towards the etched artwork area on the printing plate and again fills the etched artwork image on the plate with ink in preparation for the next cycle. After all the colors have been printed the image bearing face plate substrate is then removed from the pad printer and the ink post cured in an oven at between 70 F and 300 F and/or exposed to UV light for 15 mins up to 3 days (the times and temperature dependent on the curing profile of the ink(s) used) prior to the next step.

FIG. 2A shows a face plate substrate material having a personalized image printed on its surface. FIGS. 2B and 2C show alternative embodiments having contrasting area of light and dark shading printed across the face plate surface.

After transferring the digital image to the surface of the face plate, in one embodiment, the face plate can then be covered or coated with a protective outer coating (also referred to herein as a “polymer end cap”) which covers the indicia-bearing composite face plate. The polymer end cap will protect the face from abrasion caused by an impact and general day-to-day use (dropping the club etc.). A polymer end cap also can reduce or eliminate deterioration of the surface finish of the club face caused by sand from the golf ball.

FIG. 3 illustrates an exploded assembly view of the golf club head 6700 and a face insert 6710 including a composite face insert 6722 and a polymer cap 6724. In certain embodiments, the polymer cap 6724 is formed from a polyurethane or a polyurea. In some embodiments, the polymer cap 6725 includes a rim portion 6732 that covers a portion of a side wall 6734 of the composite insert 6722.

In other embodiments, the polymer cap 6724 does not have a rim portion 6732 but includes an outer peripheral edge that is substantially flush and planar with the side wall 6734 of the composite insert 6722. A plurality of score lines 6712 can be located on the polymer cap 6724. The composite face insert 6710 may have a variable thickness and is adhesively or mechanically attached to the insert ear 6726 located within the front opening and connected to the front opening inner wall 6714. The insert ear 6726 and the composite face insert 6710 can be of the type described in U.S. patent application Ser. Nos. 11/998,435, 11/642,310, 11/825,138, 11/823,638, 12/004,386, 12/004,387, 11/960,609, 11/960,610 and U.S. Pat. No. 7,267,620, which are herein incorporated by reference in their entirety.

The polymer end cap is made from a polymer and can include a textured or roughened surface The polymeric materials and polymer end cap for use in the golf clubs of the present are more fully described in copending US Publication No. 2009/0163291A1, filed on Dec. 19, 2007, and US Publication No. 2012/0172143A1, filed on Dec. 19, 2011, the entire contents of each of which are incorporated by reference herein.

A list of suitable polymers that can be used to prepare a polymer cap on a face plate is provided below. A particularly desirable polymer is polyurethane. For an outer layer 150 made of polyurethane, the thickness of the layer desirably is in the range of about 0.2 mm to about 1.2 mm, with about 0.4 mm being a specific example.

One preferred family of polymers for making the polymer end cap are the thermoplastic or thermoset polyurethanes and polyureas made by combination of a polyisocyanate and a polyol or polyamine respectively. Any isocyanate available to one of ordinary skill in the art is suitable for use in the structures and methods disclosed herein, but not limited to, aliphatic, cycloaliphatic, aromatic aliphatic, aromatic, any derivatives thereof, and combinations of these compounds having two or more isocyanate (NCO) groups per molecule, as described in more detail in.

Any polyol available to one of ordinary skill in the polyurethane art is suitable for use with the structures and methods disclosed herein. Polyols suitable for use include, but are not limited to, polyester polyols, polyether polyols, polycarbonate polyols and polydiene polyols such as polybutadiene polyols, as described below in more detail.

Any polyamine available to one of ordinary skill in the polyurea art is suitable for use with the structures and methods disclosed herein. Polyamines suitable for use include, but are not limited to, amine-terminated hydrocarbons, amine-terminated polyethers, amine-terminated polyesters, amine-terminated polycaprolactones, amine-terminated polycarbonates, amine-terminated polyamides, and mixtures thereof, as described below in more detail.

The previously described diisocyanate and polyol or polyamine components may be previously combined to form a prepolymer prior to reaction with the chain extender or curing agent. Any such prepolymer combination is suitable for use in the structures and methods disclosed herein. Commercially available prepolymers include LFH580, LFH120, LFH710, LFH1570, LF930A, LF950A, LF601D, LF751D, LFG963A, and LFG640D, as described below in more detail.

One preferred prepolymer is a toluene diisocyanate prepolymer with polypropylene glycol. Such polypropylene glycol terminated toluene diisocyanate prepolymers are available from Chemtura of Middlebury, Conn., under the trade name ADIPRENE® LFG963A and LFG640D. Most preferred prepolymers are the polytetramethylene ether glycol terminated toluene diisocyanate prepolymers including those available from Chemtura of Middlebury, Conn., under the trade name ADIPRENE® LF930A, LF950A, LF601D, and LF751D. In certain embodiments, a blend of prepolymers may be used.

The polymer end cap may be prepared from a polyurethane or polyurea having a material Shore D hardness of 30 to 80, more particularly 40 to 70, and most particularly 40-60. After application of the polymer end cap to the face plate, the effective hardness of the capped face plate as measured on the face of the club is of from about 10 to about 100, preferably of from about 20 to about 90, more preferably of from about 30 to about 85 and most preferably of from about 70 to about 80 Shore D. The polymer end cap also has a thickness of 0.1 to 1 mm, more particularly 0.2 to 0.6 mm, most particularly 0.2 to 0.5 mm, and especially 0.3 to 0.35 mm. The polymer material also has a flexural modulus of from about 2 to about 120 kpsi, and more particularly of from about 5 to about 110 kpsi, which provides superior abrasion resistance and durability.

In one embodiment, material used to prepare the polymer end cap has a low material flexural modulus of from about 2 to about 70 kpsi, more particularly of from about 5 to about 20 kpsi). A low flexural modulus material can be obtained, for example, with a polyurethane prepolymer or polyurea prepolymer that has of from about 3 to about 10 mol % free NCO groups and/or utilizing a fast-reacting polyamine curative.

In another embodiment, the material used to prepare the polymer end cap has a high material flexural modulus (e.g., of from about 60 to about 120 kpsi. more particularly of from about 70 to about 110 kpsi),). A high flexural modulus material can be obtained, for example, with a polyurethane prepolymer or polyurea prepolymer that has of from about 5 to about 20 mol % free NCO groups and/or utilizing a slow-reacting polyamine curative.

The prepolymer and the curative blend components are dynamically mixed using a standard urethane dispenser available in the market and known to any in the art of liquid polyurethane chemistry employed in the industry. A mixer such as the SEE-Flo 2K Gear Meter Mix Dispense System—Model 995 by Sealant Equipment Company) may be employed to mix and dispense the two components at the right ratio on to the part before molding. Here the prepolymer and curative are maintained in tanks and recirculated at the required temperatures and flow-rate to maintain the right ratio between the prepolymer and curative blend and a 3-way valve or switching system is employed to pour the material through a mixer on to the part. The mixer may be a static or dynamic mixer.

### Application of Polymer End Cap to the Image Bearing Face Plate

In order to apply the polymer end cap to the image bearing face plate a molding process is used. The image bearing face plate may be mounted onto a two piece mold, the mold having an upper part with fastening means (clips or vacuum) for holding the substrate in place. The lower part of the mold has on its interior surface any texture and/or scorelines which will be subsequently imparted to the final piece which is configured to receive the polymer mixture prepared and dispensed as described above and used to form the endcap.

Any compression molding machine or equipment that gives the required tonnage and temperature that is available in the market may be employed to compress the dispensed material at a given temperature of 100-300° F. from 2-20 minutes, sufficient to yield a cured or crosslinked image bearing face plate molded to the polymer end cap that can be demolded. The part is the post-cured to the fully crosslinked state at 200-250° F. for 16-24 hours before any other operations such as cutting and bonding are performed.

After reaching full-cure, the image bearing face plate molded to the polymer end cap part is subjected to manufacturing techniques (machining, forming, etc.) that achieve the specified final dimensions, size, contours, etc., of the components for use as face plates on club-heads. Conventional CNC trimming can be used to remove any sacrificial portion of the fully-cured part. However, because the tool applies a lateral cutting force to the part (against the peripheral edge of the part), it has been found that such trimming can pull fibers or portions thereof out of their plies and/or induce horizontal cracks on the peripheral edge of the part. These defects can cause premature delamination or other failure.

In certain embodiments, the sacrificial portion of the fully-cured part is removed by water-jet cutting. In water-jet cutting, the cutting force is applied in a direction perpendicular to the prepreg plies (in a direction normal to the front and rear surfaces of the lay-up), which minimizes the occurrence of cracking and fiber pull out. Consequently, water-jet cutting can be used to increase the overall durability of the part.

Attaching the face plate to the support of the club-head body may be achieved using an appropriate adhesive (typically an epoxy adhesive or a film adhesive cavity such as 3M Scotch-Weld DP-420 adhesive which is cured for 30 minutes to 1 hour at 70° C. before use). To prevent peel and delamination failure at the junction of an all-composite face plate with the body of the club-head, the composite face plate can be recessed from or can be substantially flush with the plane of the forward surface of the metal body at the junction. Desirably, the face plate is sufficiently recessed so that the ends of the reinforcing fibers in the composite component are not exposed.

In addition to the indicia-bearing composite face, the metal wood golf club heads disclosed herein may also incorporate features that provide the golf club heads and/or golf clubs with increased moments of inertia low centers of gravity, and centers of gravity located in preferable locations as well as features which allow adjustability of the golf clubs loft angle lie angle and face angle.

### Movable Weights

Various approaches can be used for positioning discretionary mass within a golf club head. For example, many club heads have integral sole weight pads cast into the head at predetermined locations that can be used to lower, to move forward, to move rearward or otherwise to adjust the location of the club head's center-of-gravity. Also, epoxy can be added to the interior of the club head through the club head's hosel opening to obtain a desired weight distribution. Alternatively, weights formed of high-density materials can be attached to the sole, skirt, and other parts of a club head. With such methods of distributing the discretionary mass, installation is critical because the club head endures significant loads during impact with a golf ball that can dislodge the weight. Accordingly, such weights are usually permanently attached to the club head and are limited to a fixed total mass, which of course, permanently fixes the club head's center-of-gravity and moments of inertia.

Another method involves the use of so called movable weights which can be adjusted by the manufacturer and the user to adjust the position of the center of gravity of the club to give the desired performance characteristics. This feature is described in more detail in the following U.S. Pat. Nos. 6,773,360, 7,166,040, 7,452,285, 7,628,707, 7,186,190, 7,591,738, 7,963,861, 7,621,823, 7,448,963, 7,568,985, 7,578,753, 7,717,804, 7,717,805, 7,530,904, 7,540,811, 7,407,447, 7,632,194, 7,846,041, 7,419,441, 7,713,142, 7,744,484, 7,223,180, 7,410,425 and 7,410,426, the entire contents of each of which are incorporated by reference in their entirety herein.

Thus the golf club head can define one or more weight ports formed in the body that are configured to receive one or more weights. For example, one or more weight ports can be disposed in the crown 12, skirt 16 and/or sole 14 of the club head. The weight ports can have any of a number of various configurations to receive and retain any of a number of weights or weight assemblies. The weights may have a weight of from about 1 to about 18 grams. In some embodiments a combination of lighter weights having a weight of from about 1 to about 3 grams and heavier weights having a weight of from about 6 to about 18 grams are used. For example, as shown in more detail in FIGS. 4-7, one exemplary club head 28 includes four recesses 96, 98, 102, 104 about periphery of the club head. In the exemplary embodiment, four weights are provided as shown in FIG. 8, two weight assemblies 30 of about 10 grams and two weight screws 32 of about 2 grams. Varying placement of the weights enables the golfer to vary launch conditions in the club head, for optimum distance and accuracy. More specifically, the golfer can adjust the position of the club head's center of gravity, for greater control over the characteristics of launch conditions and, therefore, the trajectory and shot shape of the golf ball.

With reference to FIGS. 4-8, the weights 24 are sized to be securely received in any of the four recesses 96, 98, 102, 104 of the club head 28, and are secured in place using a torque wrench. In the exemplary embodiment, the CG of the club head can be adjustably located in an area adjacent to the sole having a length of about five millimeters measured from front-to-rear and width of about five millimeters measured from toe-to-heel. Each configuration delivers different launch conditions, including launch angle, spin-rate and the club head's alignment at impact.

### Adjustable Lie/Loft Connection Assembly

In addition to the composite face and indicia, the metal wood golf club heads of disclosed herein may also incorporate features that provide the golf club heads and/or golf clubs with the ability to adjust the loft and/or the lie angle of the club by employing a removable head-shaft connection assembly. The adjustable lie/loft connection assembly is described in more detail in U.S. Pat. No. 8,025,587 issuing on Sep. 27, 2011, U.S. Pat. No. 8,235,831 issuing on Aug. 7, 2012, U.S. Pat. No. 8,337,319 issuing on Dec. 25, 2012, as well as copending US Publication No. 2011/0312437A1 filed on Jun. 22, 2011, US Publication No. 2012/0258818 A1 filed on Jun. 20, 2012, US Publication No. 2012/0122601A1 filed on Dec. 29, 2011, US Publication No. 2012/0071264 A1 filed on Mar. 22, 2011 as well as copending U.S. application Ser. No. 13/686,677 filed on Nov. 27, 2012, the entire contents of which patent, publications and application are incorporated in their entirety by reference herein.

FIG. 9 shows one embodiment of a gold club assembly that has a removable shaft that can be supported at various positions relative to the head to vary the shaft loft and/or the lie angle of the club. The assembly comprises a club head 3000 having a hosel 3002 defining a hosel opening 3004. The hosel opening 3004 is dimensioned to receive a shaft sleeve 3006, which in turn is secured to the lower end portion of a shaft 3008. The shaft sleeve 3006 can be adhesively bonded, welded or secured in equivalent fashion to the lower end portion of the shaft 3008. In other embodiments, the shaft sleeve 3006 can be integrally formed with the shaft 3008. As shown, a ferrule 3010 can be disposed on the shaft just above the shaft sleeve 3006 to provide a transition piece between the shaft sleeve and the outer surface of the shaft 3008.

The hosel opening 3004 is also adapted to receive a hosel insert 200, which can be positioned on an annular shoulder 3012 inside the club head. The hosel insert 200 can be secured in place by welding, an adhesive, or other suitable techniques. Alternatively, the insert can be integrally formed in the hosel opening. The club head 3000 further includes an opening 3014 in the bottom or sole of the club head that is sized to receive a screw 400. The screw 400 is inserted into the opening 3014, through the opening in shoulder 3012, and is tightened into the shaft sleeve 3006 to secure the shaft to the club head. The shaft sleeve 3006 is configured to support the shaft at different positions relative to the club head to achieve a desired shaft loft and/or lie angle.

The shaft sleeve 3006 is shown in greater detail in FIGS. 44-47. The shaft sleeve 3006 in the illustrated embodiment comprises an upper portion 3016 having an upper opening 3018 for receiving and a lower portion 3020 located below the lower end of the shaft. The lower portion 3020 can have a threaded opening 3034 for receiving the threaded shaft of the screw 400. The lower portion 3020 of the sleeve can comprise a rotation prevention portion configured to mate with a rotation prevention portion of the hosel insert 200 to restrict relative rotation between the shaft and the club head. As shown, the rotation prevention portion can comprise a plurality of longitudinally extending external splines 500 that are adapted to mate with corresponding internal splines 240 of the hosel insert 200.

The upper portion 3016 of the sleeve extends at an offset angle 3022 relative to the lower portion 3020. As shown in FIG. 43, when inserted in the club head, the lower portion 3020 is co-axially aligned with the hosel insert 200 and the hosel opening 3004, which collectively define a longitudinal axis B. The upper portion 3016 of the shaft sleeve 3006 defines a longitudinal axis A and is effective to support the shaft 3008 along axis A, which is offset from longitudinal axis B by offset angle 3022. Inserting the shaft sleeve at different angular positions relative to the hosel insert is effective to adjust the shaft loft and/or the lie angle, as further described below.

As best shown in FIG. 9, the upper portion 3016 of the shaft sleeve desirably has a constant wall thickness from the lower end of opening 3018 to the upper end of the shaft sleeve. A tapered surface portion 3026 extends between the upper portion 3016 and the lower portion 3020. The upper portion 3016 of the shaft sleeve has an enlarged head portion 3028 that defines an annular bearing surface 3030 that contacts an upper surface 3032 of the hosel 3002 (FIG. 43). The bearing surface 3030 desirably is oriented at a 90-degree angle with respect to longitudinal axis B so that when the shaft sleeve is inserted in to the hosel, the bearing surface 3030 can make complete contact with the opposing surface 3032 of the hosel through 360 degrees.

As further shown in FIG. 9, the hosel opening 3004 desirably is dimensioned to form a gap 3024 between the outer surface of the upper portion 3016 of the sleeve and the opposing internal surface of the club head. Because the upper portion 3016 is not co-axially aligned with the surrounding inner surface of the hosel opening, the gap 3024 desirably is large enough to permit the shaft sleeve to be inserted into the hosel opening with the lower portion extending into the hosel insert at each possible angular position relative to longitudinal axis B. For example, in the illustrated embodiment, the shaft sleeve has eight external splines 500 that are received between eight internal splines 240 of the hosel insert 200. The shaft sleeve and the hosel insert can have the configurations shown in FIGS. 10-13, respectively. This allows the sleeve to be positioned within the hosel insert at two positions spaced 180 degrees from each other, as previously described.

As can be appreciated, the assembly shown in FIGS. 9-13 permits a shaft to be supported at different orientations relative to the club head to vary the shaft loft and/or lie angle. Other shaft sleeve and hosel insert configurations can be used to vary the number of possible angular positions for the shaft sleeve relative to the longitudinal axis B.

### Adjustable Sole Plate

Conventional clubs do not allow for adjustment of the hosel/shaft loft without causing a corresponding change in the face angle. The grounded loft of a club head is the vertical angle of the centerface normal vector when the club is in the address position (i.e., when the sole is resting on the ground), or stated differently, the angle between the club face and a vertical plane when the club is in the address position. When the shaft loft of a club is adjusted, such as by employing the adjustable lie/loft connection assembly described herein, or by traditional bending of the shaft, the grounded loft does not change because the orientation of the club face relative to the sole of the club head does not change. On the other hand, adjusting the shaft loft is effective to adjust the square loft of the club by the same amount. Similarly, when shaft loft is adjusted and the club head is placed in the address position, the face angle of the club head increases or decreases in proportion to the change in shaft loft. For example, for a club having a 60-degree lie angle, decreasing the shaft loft by approximately 0.6 degree increases the face angle by +1.0 degree, resulting in the club face being more “open” or turned out. Conversely, increasing the shaft loft by approximately 0.6 degree decreases the face angle by −1.0 degree, resulting in the club face being more “closed” or turned in.

In some implementations, an adjustable mechanism is provided on the sole 14 to “decouple” the relationship between face angle and hosel/shaft loft, i.e., to allow for separate adjustment of square loft and face angle of a golf club. For example, some embodiments of the golf club head 2 include an adjustable sole portion that can be adjusted relative to the club head body 2 to raise and lower the rear end of the club head relative to the ground. Further detail concerning the adjustable sole portion is provided in U.S. Pat. No. 8,337,319 issuing on Dec. 25, 2012, U.S. Patent Publication Nos. US2011/0152000 A1 filed on Dec. 23, 2009, US2011/0312437 filed on Jun. 22, 2011, US2012/0122601A1 filed on Dec. 29, 2011 and copending U.S. application Ser. No. 13/686,677 filed on Nov. 27, 2012, the entire contents of each of which are incorporated herein by reference.

FIGS. 14-18 illustrate a golf club head 8000 according that also includes an adjustable sole portion. As shown in FIGS. 14A-14F, the club head 8000 comprises a club head body 8002 having a heel 8005, a toe 8007, a rear end 8006, a forward striking face 8004, a top portion or crown 8021, and a bottom portion or sole 8022. The body also includes a hosel 8008 for supporting a shaft (not shown). The sole 8022 defines a leading edge surface portion 8024 adjacent the lower edge of the striking face 8004 that extends transversely across the sole 8022 (i.e., the leading edge surface portion 8024 extends in a direction from the heel 8005 to the toe 8007 of the club head body). The hosel 8008 can be adapted to receive a removable shaft sleeve 8009, as disclosed herein.

The sole 8022 further includes an adjustable sole portion 8010 (also referred to as a sole piece) that can be adjusted relative to the club head body 8002 to a plurality of rotational positions to raise and lower the rear end 8006 of the club head relative to the ground. This can rotate the club head about the leading edge surface portion 8024 of the sole 8022, changing the sole angle 2018. As best shown in FIG. 15, the sole 8022 of the club head body 8002 can be formed with a recessed cavity 8014 that is shaped to receive the adjustable sole portion 8010.

As best shown in FIG. 17A, the adjustable sole portion 8010 can be triangular. In other embodiments, the adjustable sole portion 8010 can have other shapes, including a rectangle, square, pentagon, hexagon, circle, oval, star or combinations thereof. Desirably, although not necessarily, the sole portion 8010 is generally symmetrical about a center axis as shown. As best shown in FIG. 17C, the sole portion 8010 has an outer rim 8034 extending upwardly from the edge of a bottom wall 8012. The rim 8034 can be sized and shaped to be received within the walls of the recessed cavity 8014 with a small gap or clearance between the two when the adjustable sole portion 8010 is installed in the body 8002. The bottom wall 8012 and outer rim 8034 can form a thin-walled structure as shown. At the center of the bottom surface 8012 can be a recessed screw hole 8030 that passes completely through the adjustable sole portion 8010.

A circular, or cylindrical, wall 8040 can surround the screw hole 8030 on the upper/inner side of the adjustable sole portion 8010. The wall 8040 can also be triangular, square, pentagonal, etc., in other embodiments. The wall 8040 can be comprised of several sections 8041 having varying heights. Each section 8041 of the wall 8040 can have about the same width and thickness, and each section 8041 can have the same height as the section diametrically across from it. In this manner, the circular wall 8040 can be symmetrical about the centerline axis of the screw hole 8030. Furthermore, each pair of wall sections 8041 can have a different height than each of the other pairs of wall sections. Each pair of wall sections 8041 is sized and shaped to mate with corresponding sections on the club head to set the sole portion 8010 at a predetermined height

As shown in FIG. 16A-C, the recessed cavity 8014 in the sole 8022 of the body 8002 can be shaped to fittingly receive the adjustable sole portion 8010. The cavity 8014 can include a cavity side wall 8050, an upper surface 8052, and a raised platform, or projection, 8054 extending down from the upper surface 8052. The cavity wall 8050 can be substantially vertical to match the outer rim 8034 of the adjustable sole portion 8010 and can extend from the sole 8022 up to the upper surface 8052. The upper surface 8052 can be substantially flat and proportional in shape to the bottom wall 8012 of the adjustable sole portion 8010. As best shown in FIG. 70, the cavity side wall 8050 and upper surface 8052 can define a triangular void that is shaped to receive the sole portion 8010. In alternative embodiments, the cavity 8014 can be replaced with an outer triangular channel for receiving the outer rim 8034 and a separate inner cavity to receive the wall sections 8041. The cavity 8014 can have various other shapes, but desirably is shaped to correspond to the shape of the sole portion 8010. For example, if the sole portion 8010 is square, then the cavity 8014 desirably is square.

As shown in FIG. 16 A, the raised platform 8054 can be geometrically centered on the upper surface 8052. The platform 8054 can be bowtie-shaped and include a center post 8056 and two flared ears 8058 extending from opposite sides of the center post, as shown in FIG. 16D. The platform 8054 can also be oriented in different rotational positions with respect to the club head body 8002. For example, FIG. 16E shows an embodiment wherein the platform 8054 is rotated 90-degrees compared to the embodiment shown in FIG. 16A.

A releasable locking mechanism or retaining mechanism desirably is provided to lock or retain the sole portion 8010 in place on the club head at a selected rotational orientation of the sole portion. For example, at least one fastener can extend through the bottom wall 8012 of the adjustable sole portion 8010 and can attach to the recessed cavity 8014 to secure the adjustable sole portion to the body 8002. In the embodiment shown in FIG. 15, the locking mechanism comprises a screw 8016 that extends through the recessed screw hole 8030 in the adjustable sole portion 8010 and into a threaded opening 8060 in the recessed cavity 8014 in the sole 8022 of the body 8002. In other embodiments, more than one screw or another type of fastener can be used to lock the sole portion in place on the club head.

In the embodiment shown in FIG. 14D, the triangular sole portion 8010 has a first corner 8018 located toward the heel 8005 of the club head and a second corner 8020 located near the middle of the sole 8022. A third corner 8019 is located rearward of the screw 8016. In this manner, the adjustable sole portion 8010 can have a length (from corner 8018 to corner 8020) that extends heel-to-toe across the club head less than half the width of the club head at that location of the club head. The adjustable sole portion 8010 is desirably positioned substantially heelward of a line L (see FIG. 14D) that extends rearward from the center of the striking face 8004 such that a majority of the sole portion is located heelward of the line L. As noted above, studies have shown that most golfers address the ball with a lie angle between 10 and 20 degrees less than the intended scoreline lie angle of the club head (the lie angle when the club head is in the address position). The length, size, and position of the sole portion 8010 in the illustrated embodiment is selected to support the club head on the ground at the grounded address position or any lie angle between 0 and 20 degrees less than the lie angle at the grounded address position while minimizing the overall size of the sole portion (and therefore, the added mass to the club head). In alternative embodiments, the sole portion 8010 can have a length that is longer or shorter than that of the illustrated embodiment to support the club head at a greater or smaller range of lie angles. For example, in some embodiments, the sole portion 8010 can extend past the middle of the sole 8022 to support the club head at lie angles that are greater than the scoreline lie angle (the lie angle at the grounded address position).

It can be appreciated that the non-circular shape of the sole portion 8010 and the recessed cavity 8014 serves to help prevent rotation of the sole portion relative to the recessed cavity and defines the predetermined positions for the sole portion. However, the adjustable sole portion 8010 could have a circular shape (not shown). To prevent a circular outer rim 8034 from rotating within a cavity, one or more notches can be provided on the outer rim 8034 that interact with one or more tabs extending inward from the cavity side wall 8050, or vice versa. In such circular embodiments, the sole portion 8010 can include any number of pairs of wall sections 8041 having different heights. Sufficient notches on the outer rim 8034 can be provided to correspond to each of the different rotational positions that the wall sections 8041 allow for.

### Examples

### Method for Pad Printing Composite Faced Golf Club

A substrate plate having the required dimension (including any sacrificial area) for the final face insert was selected. The substrate was made from a composite prepared as described in US 2009/0163291. Alignment holes were drilled in the plate to hold and position the plate for the priming process, the pad printing process and the urethane over molding process and the final water jet face cutting process.

The substrate plate was first deburred using a grinding wheel or belt sander to remove sharp edges and the plate was then subjected to an acetone wipe on the front and back and the front face further abraded with a soft grinding wheel prior to a manual water wash and air drying. The part was then further treated in an ultrasonic acetone bath. The sample was then exposed to a plasma treatment in a vacuum chamber for 3 minutes at a high setting. The vacuum was adjusted to produce the maximum plasma discharge in the chamber. The surface of the substrate was then treated with a Chockwang W (U) primer.

The Chockwang W primer which is clear was premixed with white pigment using color concentrate added to at a mix of 100 parts primer to 10 parts H2O to 10 parts CX100 (primer catalyst) to 12 parts color concentrate and sprayed on the plate surface using a regular paint spray gun or automated spraying line.

(If a black face is desired the primer which is clear is premixed with carbon black pigment using color concentrate added to at a mix of 100 parts primer to 10 parts H2O to 10 parts CX100 (primer catalyst) to 6 parts color concentrate prior to spraying. Other pigment packages can be utilized to produce alternative face appearances.)

After treatment with the primer package, the primed plate was then post cured in a forced convection oven at 130° F. for 20 mins. prior to pad printing.

### Pad Printing

Step 1—An aluminum plate having the same alignment holes as the composite plate was used to align the printed image. In addition to these holes, the aluminum plate has 4 targets located at the circumference on the image. The graphic is broken out into its constituent colors. For a process print these are Black, Cyan, Magenta, and Yellow. Each of these colored images has the same targets located around the circumference. The setup plate and the targets allow each color to be lined up using the targets independently. Once each color is lined up the setup plate is removed and the composite plates are ready to print.
Step 2—The primed plate was placed on a Pad printing machine (Model No. XE 13 from Pad Print machinery of Vermont) using the previously drilled alignment holes.
Step 3—After all the colors were printed the plate was post cured in an oven at 200 F for 15 mins.

### Preparation of Polymer End Cap

### Preparation of the Polymer Mixture

Using a SEE-Flo 2K Gear Meter Mix Dispense System (Model 995 by Sealant Equipment Company), the prepolymer and curative were maintained in tanks and recirculated at the required temperatures and flow-rate to maintain the right ratio between the prepolymer and curative blend, and a 3-way valve or switching system was employed to pour the material through the mixer on to the part. The mixer may be a static or dynamic mixer.

### Application of End Cap

The treated substrate was mounted onto a two piece mold, the mold having an upper part with fastening means (clips or vacuum) for holding the substrate in place. The lower part of the mold has on its interior surface any texture and/or scorelines which will be subsequently imparted to the final piece which is configured to receive the polymer mixture used to form the final part/endcap

Any compression molding machine was employed to compress the dispensed material at a given temperature of 100-300° F. from 2-20 minutes, sufficient to yield a cured or crosslinked part that can be demolded. The parts were later post-cured to their fully crosslinked state at 200-250° F. for 16-24 hours before any other operations such as cutting and bonding are performed.

Using a semi-continuous urethane dispenser and mixer (Sealant Equipment Engineering Servo-Flo 704) the required amount (about 6 grams) was dispensed via the semi-continuous dynamic mixhead onto the bottom part of the mold. (Alternately, dispense may be made to the upper mold half). The upper mold half was then closed and compressed in a compression press from 8-20 kpsi pressure and held for about 6 to 12 minutes at 150° F. A mold release may be used prior to molding to help demold the cured part easily. This part was then washed and post-cured for 16 hours at 200° F.

This molded part was then cut using a CNC machine or water-jet method as described in U.S. Pat. No. 7,874,937 (the entire contents of which are incorporated by reference herein) to conform to the driver head. Attaching the face plate to the support of the club-head body was be achieved using an appropriate adhesive (typically an epoxy adhesive or a film adhesive cavity such as 3M Scotch-Weld DP-420 adhesive which was cured for 30 minutes to 1 hour at 70° C. before use). To prevent peel and delamination failure at the junction of the all-composite face plate with the body of the club-head, the composite face plate can be recessed from or can be substantially flush with the plane of the forward surface of the metal body at the junction. Desirably, the face plate is sufficiently recessed so that the ends of the reinforcing fibers in the composite component are not exposed.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

1. A golf club-head comprising:
A) a body having a crown, a heel, a toe, and a sole, the body defining a front opening; and
B) a face plate closing the front opening of the body, the insert comprising a lay-up of multiple, composite prepreg plies, wherein at least a portion of the plies comprise a plurality of elongated prepreg strips defining an overlapping region where the strips overlap each other; and wherein
the face plate further comprises an exterior and interior surface and having an image or indicia printed on the exterior surface.

2. The golf club head of claim 1 wherein the image or indicia comprises a digital image having at least one color.

3. The golf club head of claim 1 wherein the image is formed as a result of a process selected from the group consisting of halftone printing, relief printing, thermal transfer printing, ink-jet printing and pad printing.

4. The golf club head of claim 1 wherein the image is formed as a result of a pad printing process.

5. The golf club head of claim 1 wherein the face plate includes a polymer end cap secured to the front surface of the face plate, the polymer end cap.

6. The golf club head of claim 5, wherein the face plate has an effective Shore D hardness of from about 70 to about 80.

7. The golf club head of claim 5, wherein the polymer end cap comprises a polymer selected from the group consisting of an ionomer, a polyurethane, a polyurea and any and all mixtures thereof.

8. The golf club head of claim 5, wherein a thickness of the polymer end cap is of from about 0.1 mm to about 1.0 mm.

9. A golf club, comprising
a. a body having a crown, a heel, a toe, and a sole, the body defining a front opening; and
b. a face plate closing the front opening of the body, the face plate comprising a lay-up of multiple, composite prepreg plies, wherein at least a portion of the plies comprise a plurality of elongated prepreg strips defining an overlapping region where the strips overlap each other; and wherein
c. the face plate further comprises an exterior and interior surface and having an image or indicia printed on the exterior surface;
the body further comprising
d. a hosel having an upper bearing surface; and
e. a hosel bore defining a hosel bore axis;
f. an adjustable sleeve comprising a plurality of engaging surfaces that engage with the body to restrict rotation of the sleeve relative to the body such that the sleeve is configured to be secured within the hosel bore in a plurality of discrete rotational positions relative to the hosel bore axis,
i. the sleeve further comprising a shaft bore defining a shaft bore axis that forms a sleeve angle with the hosel bore axis when the sleeve is secured within the hosel bore, the shaft bore being secured to a distal end portion of the shaft such that the shaft extends along the shaft bore axis; and
ii. a retainer configured to releasably secure a distal end portion of the sleeve to the body in one of the rotational positions;
wherein the square loft angle of the golf club head can be adjusted to a plurality of different values by changing the rotational position of the sleeve within the hosel bore; and
wherein, when the sleeve is secured to the body via the retainer in one of the rotational positions, an intermediate portion of the sleeve extending axially from a lowest portion of the upper bearing surface of the hosel to a distal end of the shaft is under a tension that is constant along the axial length of the intermediate portion of the sleeve.

10. A golf club, comprising
a. a body having a crown, a heel, a toe, and a sole, the body defining a front opening; and
b. a face plate closing the front opening of the body, the face plate comprising a lay-up of multiple, composite prepreg plies, wherein at least a portion of the plies comprise a plurality of elongated prepreg strips defining an overlapping region where the strips overlap each other; and wherein
c. the face plate further comprises an exterior and interior surface and having an image or indicia printed on the exterior surface;
the body further comprising
d. a rotatably adjustable sole piece adapted to be positioned at a plurality of rotational and axial positions with respect to an axis extending through the sole piece, wherein the adjustable sole piece can be locked on the sole at three or more discrete selectable positions, wherein the adjustable sole piece extends a different distance from the sole at each of the three or more positions; and
e. a releasable locking mechanism configured to lock the sole piece at a selected one of the three or more rotational positions on the sole, wherein the locking mechanism comprises a screw adapted to extend through the sole piece and into a threaded opening in the sole of the club head body.

11. The golf club head of claim 10, wherein the sole piece comprises an outer wall that includes a plurality of notches that are configured to engage with corresponding ridges on the sole of the club head body to prevent the sole piece from rotating such that when the sole piece is secured to the sole it can be locked on the sole at six or more discrete selectable positions, wherein the adjustable sole piece extends a different distance from the sole at each of the six or more positions.

12. A golf club, comprising
a. a body having a crown, a heel, a toe, and a sole, the body defining a front opening; and
b. a face plate closing the front opening of the body, the face plate comprising a lay-up of multiple, composite prepreg plies, wherein at least a portion of the plies comprise a plurality of elongated prepreg strips defining an overlapping region where the strips overlap each other; and wherein
c. the face plate further comprises an exterior and interior surface and having an image or indicia printed on the exterior surface; and
wherein the body defines an interior cavity; and
i) at least a first weight port and a second weight port formed in the body; and at least one weight configured to be retained at least partially within a weight port; and
ii) at least a first weight having a mass between about 1 g and about 18 g configured to be retained at least partially within the first weight port and a second weight having a mass between about 1 g and about 18 g configured to be retained at least partially within the second weight port.

13. The wood-type golf club head according to claim 12, wherein the first weight mass is between about 6 g and about 18 g and the second weight mass is between about 1 g and about 3 g.

14. A golf club assembly comprising:
a. a shaft;
b. a body having a crown, a heel, a toe, and a sole, the body defining a front opening; and
c. a face plate closing the front opening of the body, the face plate comprising a lay-up of multiple, composite prepreg plies, wherein at least a portion of the plies comprise a plurality of elongated prepreg strips defining an overlapping region where the strips overlap each other; and wherein
d. the face plate further comprises an exterior and interior surface and having an image or indicia printed on the exterior surface;
and wherein the golf club body;
e. defines an interior cavity; having at least a first weight port and a second weight port formed in the body; and at least one weight configured to be retained at least partially within a weight port; and at least a first weight having a mass between about 1 g and about 18 g configured to be retained at least partially within the first weight port and a second weight having a mass between about 1 g and about 18 g configured to be retained at least partially within the second weight port.
f. has an adjustable sole portion that is adjustable relative to the body to adjust a sole angle of the club head,; and
g. a hosel having a hosel opening;
h. a sleeve adapted to be received in the hosel opening and having a respective opening adapted to receive a lower end portion of the shaft and support the shaft relative to the club head at a plurality of orientations, wherein the sleeve is adapted to be received in the hosel opening at a plurality of discrete rotational positions with respect to a longitudinal axis of the sleeve, with at least two of said rotational positions of the sleeve corresponding to different shaft orientations relative to the club head; and
i. a mechanical fastener adapted to releasably secure the shaft and the sleeve to the club head.

15. A method of manufacturing a golf club head comprising
a. a body having a crown, a heel, a toe, and a sole, the body defining a front opening; and
b. a face plate closing the front opening of the body, the insert comprising a lay-up of multiple, composite prepreg plies, wherein at least a portion of the plies comprise a plurality of elongated prepreg strips defining an overlapping region where the strips overlap each other; and
c. wherein the face plate further comprises an exterior and interior surface and having an image or indicia printed on the exterior surface,
wherein the method comprises the steps of;
1. preparing the exterior surface of the face plate for receiving at least one indicia;
2. providing a digital image having at least one color;
3. providing a pad-printing cliché;
4. etching the image onto the surface of the pad-printing cliché;
5. distributing a layer of ink over the etched pad-printing cliché;
6. providing at least one pad for transferring the ink from the surface of the pad-printing cliché to the exterior surface of the face plate; and
7. transferring the image from the substrate to the to the exterior surface of the face plate.

16. The method of claim 15, wherein the step of preparing the exterior surface of the face insert for receiving at least one indicia further comprises at least one of buffing, sand blasting, or plasma treating the dimpled surface.

17. The method of claim 15, further comprising the step curing the ink on the image bearing face plate by a curing method selected from the group consisting of
a. heating at a temperature of from about 70 to about 130° F. for at least 20 minutes in a convection oven;
b. exposing to U.V. light for a period of from about 15 minutes to about 3 days; and
c. any and all combinations of a. and b.

18. The method of claim 17, further comprising the step of providing a polymer end cap secured to the front surface of the face plate.

19. The method of claim 15, wherein the digital image comprises a plurality of colors.

20. The method of claim 15, wherein the etched image has a depth of from about 10 to about 100 microns.

21. The method of claim 15, wherein the etched image has a depth of from about 25 to about 80 microns.

22. The method of claim 15, wherein the etched image has a depth of from about 30 to about 60 microns.
